(19) United States
(12) Patent Application Publication
(10) Pub. No.: US 2023/0051188 A1
(43) Pub. Date: Feb. 16, 2023

(54) COMPOSITION INCLUDING UNSATURATED POLYESTER RESIN, EPOXY RESIN, AND PHOTOINITIATOR AND METHOD OF USING THE SAME

(71) Applicant: 3M INNOVATIVE PROPERTIES COMPANY, St. Paul, MN (US)

(72) Inventors: Ruijian Xu, Woodbury, MN (US); Yu Yang, Eden Prairie, MN (US); Ying Lin, Superior, CO (US); Nikki D. McRae-Brown, Inver Grove Heights, MN (US)

(21) Appl. No.: 17/785,393

(22) PCT Filed: Dec. 15, 2020
(86) PCT No.: PCT/IB2020/061980

§ 371 Date: Jun. 14, 2022

Related U.S. Application Data
(60) Provisional application No. 62/949,670, filed on Dec. 18, 2019.

(51) Int. Cl. C08F 283/01; C08F 2/50; C08G 59/68

(52) U.S. Cl. CPC C08F 283/01; C08F 2/50; C08G 59/68

(57) ABSTRACT

The composition includes a polyester resin comprising at least one α,β-unsaturated ester group, an epoxy resin, a compound comprising at least one hydroxyl group; and a photoinitiator that generates acid on exposure to actinic radiation. A method of repairing a damaged surface using the composition is also described.

### CROSS-REFERENCE TO RELATED APPLICATION

This application claims priority to U.S. Provisional Application No. 62/949,670, filed Dec. 18, 2019, the disclosure of which is incorporated by reference in its entirety herein.

### BACKGROUND

Automobile body repair is often carried out with a body repair compound, also called body filler. A body repair compound can include a thermosetting resin, fillers, promoters, and other additives that are mixed with a catalyst to facilitate cross-linking at room temperature. After mixing, a technician spreads the body filler onto a damaged surface, allows the body filler to harden, and then sands the hardened body filler to conform to the desired surface contour. The process can be repeated two or more times until the damaged area of the vehicle is sufficiently filled, and the contour of the original surface is matched.

Automotive body fillers often include unsaturated polyester resins. Unsaturated polyester resins typically contain α,β-unsaturated polyesters and 30 to 50 percent by weight copolymerizable monomers. Styrene, due to its well-understood reactivity profiles with unsaturated polyester resins and other monomers and its relatively low cost, is by far the dominant copolymerizable monomer used in unsaturated polyester resins. Styrene has a relatively high volatility which results in its being released from both uncured resins at room temperature and at much higher rates during cure. The Environmental Protection Agency (EPA) included styrene in its Toxic Release Inventory (TRI) in 1987 and classifies it as a possible carcinogen. Organizations such as the Occupational Safety and Health Administration (OSHA) and the Clean Air Act Amendments (CAAA) have included styrene in a list of volatile organic compounds to which exposure should be limited.

Some styrene-free body filler compositions have been described. See, for example, JP2005255937, published Sep. 22, 2005, and U.S. Pat. No. 5,068,125 (Meixner et al.). A visible-light polymerizable thiol-ene composition useful as a body filler is described in U.S. Pat. No. 5,876,805 (Ostlie).

### SUMMARY

The present disclosure provides a curable resin composition that includes a polyester resin, an epoxy resin, and a photoinitiator that generates acid on exposure to actinic radiation. The composition can be cured using actinic radiation and can be formulated as a body filler. The composition can provide adhesion and sanding properties comparable to existing body fillers and perform better than compositions that include a polyester resin, an epoxy resin, and only a free-radical generating photoinitiator. Advantageously, the composition of the present disclosure does not require styrene to achieve good adhesion and sanding properties.

In one aspect, the present disclosure provides a composition including a polyester resin comprising at least one α,β-unsaturated ester group, an epoxy resin, a compound comprising at least one hydroxyl group; and a photoinitiator that generates acid on exposure to actinic radiation.

In another aspect, the present disclosure provides a cured composition prepared from such a composition.

In another aspect, the present disclosure provides a method of repairing a damaged surface. The method includes applying the composition described herein to the damaged surface and exposing the composition on the damaged surface to actinic radiation to cure the composition.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The terms “cure” and “curable” refer to joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility but may be swellable in the presence of an appropriate solvent.

The term “polymer or polymeric” will be understood to include polymers, copolymers (e.g., polymers formed using two or more different monomers), oligomers that can form polymers, and combinations thereof, as well as polymers, oligomers, or copolymers that can be blended.

The term “actinic radiation” means photochemically active radiation and particle beams. Actinic radiation includes, but is not limited to, accelerated particles, for example, electron beams; and electromagnetic radiation; for example, microwaves, infrared radiation, visible light, ultraviolet light, X-rays, and gamma-rays. The radiation can be monochromatic or polychromatic, coherent or incoherent, and should be sufficiently intense to generate substantial numbers of free radicals from the photoinitiators used in the inventive compositions.

“Visible light” means light having a spectral output between about 400 and about 700 nanometers.

“Alkyl group”, “alkenyl group” and the prefix “alk-” are inclusive of both straight chain and branched chain groups. In some embodiments, alkyl groups have up to 30 carbons (in some embodiments, up to 20, 15, 12, 10, 8, 7, 6, or 5 carbons) unless otherwise specified.

“Alkylene” is the multivalent (e.g., divalent or trivalent) form of the “alkyl” groups defined above. “Alkenylene” is the multivalent (e.g., divalent or trivalent) form of the “alkenyl” groups.

“Arylalkylene” refers to an “alkylene” moiety to which an aryl group is attached. “Alkylarylene” refers to an “arylene” moiety to which an alkyl group is attached.

The phrase “interrupted by at least one —O— group”, for example, with regard to an alkyl, alkenyl, alkylene, or alkenylene group refers to having part of the alkyl or alkylene on both sides of the —O— group. For example, —CH₂CH₂—O—CH₂—CH₂— is an alkylene group interrupted by an —O—. This definition applies to the other functional groups recited herein (e.g., —N(H)—, —N(H)—C(O)—, etc.).

The terms “aryl” and “arylene” as used herein include carbocyclic aromatic rings or ring systems, for example, having 1, 2, or 3 rings and optionally containing at least one heteroatom (e.g., O, S, or N) in the ring optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

The term (meth)acrylate refers to an acrylate, a methacrylate, or a combination thereof. Similarly, the term (meth)acrylic refers to acrylic, a methacrylic, or a combination thereof.

The term “liquid” refers to being able to flow at ambient temperature.

Flash point is determined by the ASTM D93 Pensky-Martens method.

A “volatile organic compound” is a compound having at least one carbon atom that participates in atmospheric photochemical reactions. Unless otherwise specified, a volatile organic compound has at least one of a vapor pressure of greater than 0.1 mm Hg at 20° C. or a boiling point of less than 216° C.

All numerical ranges are inclusive of their endpoints and non-integral values between the endpoints unless otherwise stated (e.g., 1 to 5 includes 1, 1.5, 2, 2.75, 3, 3.80, 4, 5, etc.).

### DETAILED DESCRIPTION

The composition according to the present disclosure includes a polyester resin having at least one α,β-unsaturated ester group. Unsaturated α,β-unsaturated ester groups have the formula C═C—C(O)—O—. The terminal carbon of the double bond may be bonded to two hydrogen atoms, making it a terminal olefin group, or one or two other carbon atoms, making it an internal olefin. The terminal oxygen of the ester group is typically bonded to a carbon atom in the resin. Such unsaturated polyester resins are generally formed by a polycondensation reaction of an unsaturated dicarboxylic acid or an anhydride thereof with a multifunctional hydroxy compound. Unsaturated dicarboxylic acids useful for preparing the unsaturated polyester resin typically include α,β-unsaturated acids and anhydrides thereof (e.g., maleic anhydride, maleic acid, fumaric acid, itaconic acid, citraconic acid, and citraconic anhydride). Other dicarboxylic acids or equivalents can also be included in the preparation of the unsaturated polyester resin. Examples include saturated aliphatic dicarboxylic acids having 4 to 10 carbon atoms such as succinic acid, adipic acid, sebacic acid and/or their anhydrides; cycloaliphatic dicarboxylic acids or dicarboxylic acid anhydrides having 8 to 10 carbon atoms such as tetrahydrophthalic acid, hexahydrophthalic acid, norbornene dicarboxylic acid and/or their anhydrides; and aromatic dicarboxylic acids or dicarboxylic acid anhydrides having 8 to 12 carbon atoms such as phthalic acid, phthalic anhydride, isophthalic acid, and terephthalic acid. Examples of hydroxy compounds useful for making unsaturated polyester resins include 1,2-propanediol, 1,3-propanediol, dipropylene glycol, diethylene glycol, ethylene glycol, 1,3-butanediol, 1,4-butanediol, neopentyl glycol, triethylene glycol, tripropylene glycol, and polyethylene glycols. In some embodiments, the hydroxy compounds used to make the unsaturated polyester resin excludes alkoxylated 2-butene-1,4-diol (e.g., those described in U.S. Pat. No. 5,360,863 (Meixner et al.). Unsaturated polyester resins useful for practicing the present disclosure are typically liquid at ambient temperature, meaning they are able to flow at ambient temperature.

The unsaturated polyester resin useful for practicing the present disclosure can comprise a dicyclopentadiene-modified unsaturated polyester resin. Dicyclopentadiene has been used to modify unsaturated polyester resins in various ways. For example, cracking dicyclopentadiene (e.g., heating at a temperature of at least 140° C.) forms cyclopentadiene, which can undergo a Diels-Alder reaction with maleic acid or maleic anhydride to form nadic acid or nadic anhydride groups in the polyester backbone. In another example, maleic acid can react with one or fewer equivalents of dicyclopentadiene to form a dicyclopentenyl monoester of maleic acid. The reaction is typically carried out at a temperature lower than 140° C. to avoid cracking the dicyclopentadiene. The dicyclopentenyl monoester can then be combined with a dihydroxy compound and optionally an unsaturated dicarboxylic acid or an anhydride thereof to provide a dicyclopentenyl-end-capped polyester resin.

The polyester resin useful for practicing the present disclosure may further include other end-group modifications. For example, the polyester resin can be prepared in the presence of a vinyl monocarboxylic acid (e.g., acrylic acid, methacrylic acid, ethacrylic acid, halogenated acrylic or methacrylic acids, cinnamic acid, and combinations thereof) to provide vinyl end groups. In another example, allyl glycidyl ether and/or an unsaturated ether that is a monofunctional hydroxy compound with at least one beta, gamma-unsaturated alkenyl ether group can be useful for incorporating allyl ether end groups into the liquid polyester resin. In some embodiments, the polyester resin comprises allyl ether groups.

Mixtures of different unsaturated polyester resins may be useful in the composition according to the present disclosure. For example, a mixture of unsaturated polyesters made from different unsaturated dicarboxylic acids or anhydrides thereof and/or different dihydroxy compounds can be useful. Mixtures of dicyclopentadiene-modified unsaturated polyester resins (in some embodiments, dicyclopentenyl-end-capped polyester resin) and polyester resins not modified with dicyclopentadiene are also useful, for example, to provide a cured composition with a desirable modulus.

Unsaturated polyester resins useful for practicing the present disclosure can have a wide variety of molecular weights. Whether an unsaturated polyester resin is liquid at ambient temperature can depend, for example, on its structure (e.g., backbone and end groups) and its molecular weight. In some embodiments, the unsaturated polyester resins can have weight average molecular weights in a range from 500 grams per mole to 5,000 grams per mole, 1,000 grams per mole to 5,000 grams per mole, or 1000 grams per mole to 3,000 grams per mole, as measured by gel permeation chromatography using polystyrene standards or number average molecular weights in a range from 500 grams per mole to 5,000 grams per mole, 1,000 grams per mole to 5,000 grams per mole, or 1000 grams per mole to 3,000 grams per mole as calculated from the water collected from the condensation reaction.

The synthesis of unsaturated polyesters occurs either by a bulk condensation or by azeotropic condensation in batch. The reaction can conveniently be carried out in a flask equipped with stirrer, condenser, and a jacket heater. The starting materials are typically added to the flask at room temperature and then slowly heated to a temperature in a range from 200° C. to 250° C. under conditions where water can be removed from the reaction mass to obtain desired molecular weight.

Some unsaturated polyester resins useful for practicing the present disclosure can be obtained from commercial sources, for example, Reichhold LLC, Durham, N.C.; Polynt Composites, USA, Inc., North Kansas City, Mo.; AOC, LLC, Collierville, Tenn.; DSM Resins U.S., Inc., Augusta, Ga.; Ashland Specialty Chemical Co., Columbus, Ohio; Bayer Material Science LLC, Pittsburgh, Pa.; Interplastic Corporation, St. Paul, Minn.; and Deltech Corporation, Baton Rouge, La.

The unsaturated polyester resin or mixture of unsaturated polyester resins can be present in the composition of the present disclosure in a variety of useful amounts. For example, the unsaturated polyester resin may be present in an amount up to 80%, 75%, 70%, 60%, or 50% by weight, based on the total weight of the composition. Typically, the unsaturated polyester resin in present in an amount of at least 10%, 15%, 20%, or 25%, based on the total weight of the composition. In some embodiments, the unsaturated polyester resin is present in an amount in a range from 10% by weight to 70% by weight, 15% by weight to 60% by weight, or 20% by weight to 50% by weight, based on the total weight of the composition.

A variety of epoxy resins are useful in the composition according to the present disclosure. A monomeric polyepoxide may be an alkylene, arylene, alkylarylene, arylalkylene, or alkylenearylalkylene having at least two epoxide groups, wherein any of the alkylene, alkylarylene, arylalkylene, or alkylenearylalkylene are optionally interrupted by one or more ether (i.e., —O—), thioether (i.e., —S—), or amine (i.e., —NR¹—) groups and optionally substituted by alkoxy, hydroxyl, or halogen (e.g., fluoro, chloro, bromo, iodo). Useful monomeric polyepoxides may be diepoxides or polyepoxides with more than 2 (in some embodiments, 3 or 4) epoxide groups. An epoxy resin may be prepared by chain-extending any of such polyepoxides. It should be understood that the epoxy resin has reactive epoxide groups that can be cured, for example, using the photoinitiator that generates acid upon exposure to actinic radiation.

Some useful epoxy resins are aromatic. Useful aromatic epoxy resins typically contain at least one (in some embodiments, at least 2, in some embodiments, in a range from 1 to 4) aromatic ring (e.g., phenyl group) that is optionally substituted by a halogen (e.g., fluoro, chloro, bromo, iodo), alkyl having 1 to 4 carbon atoms (e.g., methyl or ethyl), or hydroxyalkyl having 1 to 4 carbon atoms (e.g., hydroxymethyl). For epoxy resin repeating units containing two or more aromatic rings, the rings may be connected, for example, by a branched or straight-chain alkylene group having 1 to 4 carbon atoms that may optionally be substituted by halogen (e.g., fluoro, chloro, bromo, iodo). In some embodiments, the aromatic epoxy resin is a novolac. In these embodiments, the novolac epoxy may be a phenol novolac, an ortho-, meta-, or para-cresol novolac, or a combination thereof. In some embodiments, the aromatic epoxy resin is a bisphenol diglycidyl ether, wherein the bisphenol (i.e., —O—C₆H₅—CH₂—C₆H₅—O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. In some embodiments, the epoxy resin is a novolac epoxy resin (e.g., phenol novolacs, ortho-, meta-, or para-cresol novolacs or combinations thereof), a bisphenol epoxy resin (e.g., bisphenol A, bisphenol F, halogenated bisphenol epoxies, and combinations thereof), a resorcinol epoxy resin, or a combination of any of these.

Some useful epoxy resins are non-aromatic. The non-aromatic epoxy can include a branched or straight-chain alkylene group having 1 to 20 carbon atoms optionally interrupted with at least one—O— and optionally substituted by hydroxyl. In some embodiments, the non-aromatic epoxy can include a poly(oxyalkylene) group having a plurality (x) of oxyalkylene groups, OR¹, wherein each R¹ is independently C₂ to C₅ alkylene, in some embodiments, C₂ to C₃ alkylene, x is 2 to about 6, 2 to 5, 2 to 4, or 2 to 3. Examples of useful non-aromatic monomeric polyepoxides useful for making epoxy resins include ethylene glycol diglycidyl ether, propylene glycol diglycidyl ether, diethylene glycol diglycidyl ether, dipropylene glycol diglycidyl ether, polyethylene glycol diglycidyl ether, polypropylene glycol diglycidyl ether, glycerol diglycidyl ether, propanediol diglycidyl ether, butanediol diglycidyl ether, and hexanediol diglycidyl ether. Examples of useful polyepoxides having more than two epoxide groups include glycerol triglycidyl ether, and polyglycidyl ethers of 1,1,1-trimethylolpropane, pentaerythritol, and sorbitol. Other examples of useful polyepoxides include glycidyl ethers of cycloaliphatic alcohols (e.g., 1,4-cyclohexanedimethanol, bis(4-hydroxycyclohexyl)methane or 2,2-bis(4-hydroxycyclohexyl)propane), cycloaliphatic epoxy resins (e.g., bis(2,3-epoxycyclopentyl) ether, 2,3-epoxycyclopentyl glycidyl ether, 1,2-bis(2,3-epoxycyclopentyloxy)ethane and 3,4-epoxycyclohexylmethyl 3′,4′-epoxycyclohexanecarboxylate), and hydantoin diepoxide. Examples of epoxy resins having amine groups include poly(N-glycidyl) compounds obtainable by dehydrochlorinating the reaction products of epichlorohydrin with amines containing at least two amine hydrogen atoms. These amines are, for example, aniline, n-butylamine, bis(4-aminophenyl)methane, m-xylylenediamine or bis(4-methylaminophenyl)methane. Examples of polyepoxides having thioether groups include di-S-glycidyl derivatives of dithiols (e.g., ethane-1,2-dithiol or bis(4-mercaptomethylphenyl) ether).

In some embodiments of compositions according to the present disclosure and/or useful in the methods according to the present disclosure, the polyepoxide is an oligomeric or polymeric diepoxide. In some embodiments, epoxides may be chain extended to have any desirable epoxy equivalent weight. Chain extending epoxy resins can be carried out by reacting a monomeric diepoxide, for example, with a diol in the presence of a catalyst to make a linear polymer. In some embodiments, the resulting epoxy resin (e.g., either an aromatic or non-aromatic epoxy resin) may have an epoxy equivalent weight of at least 150, 170, 200, or 225 grams per equivalent. In some embodiments, the aromatic epoxy resin may have an epoxy equivalent weight of up to 6000, 5500, 5000, 4000, 3000, 2000, 1500, or 1000 grams per equivalent. In some embodiments, the aromatic epoxy resin may have an epoxy equivalent weight in a range from 150 to 6000, 200 to 6000, 200 to 5000, 200 to 4000, 250 to 5000, 250 to 4000, 300 to 6000, 300 to 5000, 300 to 3000, 300 to 2000, or 300 to 1000 grams per equivalent. Epoxy equivalent weights may be selected, for example, so that the epoxy resin may be used as a liquid. Useful epoxy resins are available from a variety of commercial sources, for example, Hexion, Inc., Stafford, Tex.

The epoxy resin can be present in the composition of the present disclosure in a variety of useful amounts. In some embodiments, the epoxy resin is present in the composition in an amount in a range from 1% by weight to 40% by weight, 2% by weight to 30% by weight, 2% by weight to 20% by weight, or 5% by weight to 20% by weight based on the total weight of the composition.

In some embodiments, the composition of the present disclosure and/or useful for practicing the method of the present disclosure includes a compound having at least one hydroxyl group (in some embodiments, a polyol). As used herein, the term “polyol” refers to an organic compound having two or more hydroxy groups. The polyol can be added as a chain extender for the epoxy resin and can be a source of protons for a cationic polymerization reaction. In some embodiments, the polyol is a diol (i.e., polyols with two hydroxy groups). Suitable diols include 1,2-ethanediol, 1,2-propanediol, 1,3-propanediol, 1,4-butanediol, 1,3-butanediol, 2-methyl-1,3-propanediol, 2,2-dimethyl-1,3-propanediol, 2-ethyl-1,6-hexanediol, 1,5-pentanediol, 1,6-hexanediol, 1,8-octanediol, neopentyl glycol, glycerol, trimethylolpropane, 1,2,6-hexanetriol, trimethylolethane, pentaerythritol, quinitol, mannitol, sorbitol, diethylene glycol, triethylene glycol, tetraethylene glycol, glycerine, 2-ethyl-2-(hydroxymethyl)-1,3-propanediol, 2-ethyl-1,3-pentanediol, 1,4-cyclohexanedimethanol, and 1,4-benzene-dimethanol.

When a polyol is present in the composition, the polyol is typically present in an amount up to 5 wt. % or up to 2.5 wt. % based on the weight of the composition. The polyol can be present in an amount of at least 0.5 wt. %, at least 1 wt. %, or at least 2 wt. % based on the weight of the composition. The polyol is often present in an amount of 0.5 wt. % to 5 wt. %, 1 wt. % to 5 wt. %, 0.5 wt. % to 2.5 wt. %, or 1 wt. % to 2.5 wt. % based on the weight of the composition.

The composition of the present disclosure and/or useful for practicing the method of the present disclosure includes a photoinitiator that generates acid on exposure to actinic radiation. In some embodiments, the photoinitiator that generates acid on exposure to actinic radiation absorbs light in a wavelength range from 200 nm to 700 nm. In some embodiments, the photoinitiator absorbs light in the ultraviolet A (UVA) and/or blue light regions, for example, in a wavelength range from 315 nm to 550 nm or 315 nm to 500 nm. UVA light can be considered to have a wavelength range of 315 nm to 400 nm, and blue light can be considered to have a wavelength range of 400 nm to 500 nm.

Any compound that generates an acid on exposure to actinic irradiation may be useful in the compositions of the present disclosure. The acid generated may be a Lewis acid or a Bronsted acid.

Suitable acid generating compounds include onium salts and iodosyl salts, aromatic diazonium salts, metallocenium salts, o-nitrobenzaldehyde, the polyoxymethylene polymers described in U.S. Pat. No. 3,991,033, the o-nitrocarbinol esters described in U.S. Pat. No. 3,849,137, the o-nitrophenyl acetals, their polyesters, and end-capped derivatives described in U.S. Pat. No. 4,086,210, sulfonate esters of aromatic alcohols containing a carbonyl group in a position alpha or beta to the sulfonate ester group, N-sulfonyloxy derivatives of an aromatic amide or imide, aromatic oxime sulfonates, quinone diazides, and resins containing benzoin groups in the chain, such as those described in U.S. Pat. No. 4,368,253.

Suitable aromatic onium salts include those described U.S. Pat. Nos. 4,058,400 and 4,058,401. Suitable aromatic sulfoxonium salts which can be used include those described in U.S. Pat. Nos. 4,299,938, 4,339,567, 4,383,025 and 4,398,014. Suitable aliphatic and cycloaliphatic sulfoxonium salts include those described in European Patent Application Publication No. EP-AG 164 314. Aromatic iodonium salts which can be used include those described in British Patent Specification Nos. 1 516 351 and 1 539 192. Aromatic iodosyl salts which can be used include those described in U.S. Pat. No. 4,518,676.

In some embodiments, the photoinitiator that generates acid upon exposure to actinic radiation is an aromatic iodonium salt or an aromatic sulfonium salt. In these embodiments, the photoinitiator typically generates both acid and free radicals. Suitable aromatic groups for these salts include phenyl, thienyl, furanyl naphthyl, pyrazolyl groups, benzothienyl, dibenzothienyl, benzofuranyl, dibenzofuranyl, any of which may be unsubstituted or substituted by one or more of halogen, nitro, N-arylanilino groups, ester groups (e.g., methoxycarbonyl, ethoxycarbonyl, or phenoxycarbonyl), sulfo ester groups (e.g., methoxysulfonyl, butoxysulfonyl, or phenoxysulfonyl), amido groups (e.g., acetamido, butyramido, or ethylsulfonamido), carbamyl groups (e.g., carbamyl, N-alkylcarbamyl, or N-phenylcarbamyl), sulfamyl groups (e.g., sulfamyl, N-alkylsulamyl, N,N-dialkylsulfamyl, or N-phenylsulfamyl), alkoxy groups (e.g., methoxy, ethoxy, or butoxy), aryl groups (e.g., phenyl), alkyl groups (e.g., methyl, ethyl, propyl, or butyl), aryloxy groups (e.g., phenoxy) alkylsulfonyl (e.g., methylsulfonyl, or ethylsulfonyl), arylsulfonyl groups (e.g., phenylsulfonyl groups), perfluoroalkyl groups (e.g., trifluoromethyl or perfluoroethyl), and perfluoroalkylsulfonyl groups (e.g., trifluoromethylsulfonyl or perfluorobutylsulfonyl). The aromatic groups may also be bridged, for example, by —S(O)₀₋₂—, —O—, carbonyl, —N(aryl)-, a bond (e.g., as in biphenyl), or an alkylene group. Suitable counterions for the aromatic iodonium and sulfononium cations include tetrafluoroborate, hexafluorophosphate, hexafluoroarsenate, and hexafluoroantimonate.

In some embodiments, photoinitiator that generates acid upon exposure to actinic radiation is an aromatic iodonium salt. Suitable examples of aromatic iodonium salt photoinitiators include diphenyliodonium tetrafluoroborate, di(4-methylphenyl)iodonium tetrafluoroborate, phenyl-4-methylphenyliodonium tetrafluoroborate, di(4-heptylphenyl)iodonium tetrafluoroborate, di(3-nitrophenyl)iodonium hexafluorophosphate, di(4-chlorophenyl)iodonium hexafluorophosphate, di(naphthyl)iodonium tetrafluoroborate, di(4-trifluoromethylphenyl)iodonium tetrafluoroborate, diphenyliodonium hexafluorophosphate, di(4-methylphenyl)iodonium hexafluorophosphate, diphenyliodonium hexafluoroarsenate, di(4-phenoxyphenyl)iodonium tetrafluoroborate, phenyl-2-thienyliodonium hexafluorophosphate, 3,5-dimethylpyrazolyl-4-phenyliodonium hexafluorophosphate, diphenyliodonium hexafluoroantimonate, 2,2′-diphenyliodonium tetrafluoroborate di(2,4-dichlorophenyl)iodonium hexafluorophosphate, di(4-bromophenyl)iodonium hexafluorophosphate, di(4-methoxyphenyl)iodonium hexafluorophosphate, di(3-carboxyphenyl)iodonium hexafluorophosphate, di(3-methoxycarbonylphenyl)iodonium hexafluorophosphate, di(3-methoxysulfonylphenyl)iodonium hexafluorophosphate, di(4-acetamidophenyl)iodonium hexafluorophosphate, and di(2-benzothienyl)iodonium hexafluorophosphate. In some embodiments, the photoinitiator that generates acid upon exposure to actinic radiation is a diaryliodonium hexafluorophosphate or a diaryliodonium hexafluoroantimonate.

In some embodiments, photoinitiator that generates acid on exposure to actinic radiation is an aromatic sulfonium salt. The sulfur in the sulfonium salts are substituted with at one, two, or three aromatic groups. The sulfur may also be substituted with one or two alkyl groups having 1 to 20 carbon atoms and optionally substituted by halogen, hydroxy, alkoxy, or aryl. In some embodiments, the sulfonium salt is a triaryl substituted sulfonium salt. Examples of suitable aromatic sulfonium salt photoinitiators include triphenylsulfonium tetrafluoroborate, methyldiphenylsulfonium tetrafluoroborate, dimethylphenylsulfonium hexafluorophosphate, triphenylsulfonium hexafluorophosphate, triphenylsulfonium hexafluoroantimonate, diphenylnaphthylsulfonium hexafluoroarsenate, tritolysulfonium hexafluorophosphate, anisyldiphenylsulfonium hexafluoroantimonate, 4-butoxyphenyldiphenylsulfonium tetrafluoroborate, 4-chlorophenyldiphenylsulfonium hexafluoroantimonate, tris(4-phenoxyphenyl)sulfonium hexafluorophosphate, di(4-ethoxyphenyl)methylsulfonium hexafluoroarsenate, 4-acetoxy-phenyldiphenylsulfonium tetrafluoroborate, tris(4-thiomethoxyphenyl)sulfonium hexafluorophosphate, di(methoxysulfonylphenyl)methylsulfonium hexafluoroantimonate, di(methoxynaphthyl)methylsulfonium tetrafluoroborate, di(carbomethoxyphenyl)methylsulfonium hexafluorophosphate, 4-acetamidophenyldiphenylsulfonium tetrafluoroborate, dimethylnaphthylsulfonium hexafluorophosphate, trifluoromethyldiphenylsulfonium tetrafluoroborate, and methyl(N-methylphenothiazinyl)sulfonium hexafluoroantimonate.

The aromatic iodonium and sulfonium salts can be made by known methods. See for example, U.S. Pat. Nos. 3,565,906; 3,712,920; 3,759,989; and 3,763,187; F. Beringer, et al., Diaryliodonium Salts IX, J. Am. Chem. Soc. 81,342-51 (1959) and F. Beringer, et al., Diaryliodonium Salts XXIII, J. Chem. Soc. 1964, 442-51; F. Beringer, et al., lodonium Salts Containing Heterocyclic Iodine, J. Org. Chem. 30, 1141-8 (1965); J. Crivello et al., Photoinitiated Cationic Polymerization with Triarylsulfonium Salts, J. Polymer Science, 17, 977 (1979). Some are available from commercial sources.

In some embodiments, the composition of the present disclosure includes a photosensitizer. With a photosensitizer, the photoinitiator can be sensitized to the visible spectrum, for example, to allow the polymerization to be initiated at room temperature using visible light. The sensitizer can be selected, for example, based on its solubility in the composition, its compatibility with the photoinitiator, polyester, and epoxy resin in terms of shelf stability, and its absorption characteristics.

Suitable sensitizers can include ketones, coumarin dyes (e.g., keto-coumarins), xanthene dyes, acridine dyes, thiazole dyes, thiazine dyes, oxazine dyes, azine dyes, aminoketone dyes, porphyrins, aromatic polycyclic hydrocarbons, p-substituted aminostyryl ketone compounds, aminotriaryl methanes, merocyanines, squarylium dyes and pyridinium dyes. In some embodiments, the sensitizer is a ketone (e.g., monoketone or α-diketone), ketocoumarin, aminoarylketone, p-substituted aminostyryl ketone, or a combination thereof. For applications requiring deep cure (e.g., where the adhesive or the substrates attenuate radiation of similar wavelengths), sensitizers having an extinction coefficient below about 1000, or below about 100, at the desired wavelength of irradiation for photopolymerization may be useful.

Ketones useful as photosensitizers include monoketones such as 2,2-dihydroxybenzophenone, 4,4-dihydroxybenzophenone, or 2,4-dihydroxybenzophenone, di-2-pyridyl ketone, di-2-furanyl ketone, di-2-thiophenyl ketone, benzoin, fluorenones, quinones (e.g., chloroquinone), 2-aza-3-carboxy-9-fluorenone, chalcone, Michler's ketone, 2-fluoro-9-fluorenone, 2-chlorothioxanthone, 2-isopropylthioxanthone, acetophenone, benzophenone, 1- or 2-acetonaphthone, 9-acetylantracene, 2-acetylphenanthrene, 3-acetylphenanthrene or 9-acetylphenanthrene, 4-acetylbiphenyl, propiophenone, n-butyrophenone, valerophenone, 2-acetylpyridine, 3-acetylpyridine or 4-acetylpyridine, 3-acetylcoumarin. Suitable diketones include aralkyldiketones such as anthraquinone, phenanthrenequinone, o-, m- and p-diacetylbenzene, 1,3-diacetylanthracene, 1,4-diacetylanthracene, 1,5-diacetylanthracene, 1,6-diacetylanthracene, 1,7-diacetylanthracene and 1,8-diacetylnaphthalene, 1,5-diacetylanthracene, 1,8-diacetylanthracene, and 9,10-diacetylanthracene. Suitable α-diketones include 2,3-butanedione, 2,3-pentanedione, 2,3-hexanedione, 3,4-hexanedionc, 2,3-heptanedione, 3,4-heptanedione, 2,3-octanedione, 4,5-octanedione, benzil, 2,2′-dihydroxylbenzil, 3,3′-dihydroxylbenzil and 4,4′-dihydroxylbenzil, furil, di-3,3′-indolylethanedione, 2,3-bornanedione (camphorquinone), 1,2-cyclohexanedione, 1,2-naphthaquinone, and acenaphthaquinone. In some embodiments, the photosensitizer is (+/−) camphorquinone.

In some embodiments, the composition of the present disclosure and/or useful in the method of the present disclosure includes an electron donor. A variety of electron donors may be useful in the composition. Suitability as an electron donor may be determined using the evaluations described in U.S. Pat. No. 6,187,833 (Oxman et al.). Suitable electron donors include amines, amides, ethers, thioethers, ureas, thioureas, ferrocene, sulfinic acids and their salts, salts of ferrocyanide, ascorbic acid and its salts, dithiocarbamic acid and its salts, salts of xanthates, salts of ethylene diamine tetraacetic acid, salts of tetraphenylboronic acid, anthracene, and substituted anthracenes. Some useful donors include electron donor atoms such as nitrogen, oxygen, phosphorous, and sulfur.

In some embodiments, the electron donor is an aromatic amine. Suitable aromatic amine electron donors include those represented by formula Ar—N(R¹)—C(H)(R¹)₂. In formula Ar—N(R¹)—C(H)(R¹)₂, each R¹ is independently H; C₁₋₈ alkyl that is optionally substituted by one or more halogen, —CN, —OH, —SH, C₁₋₁₈ alkoxy, C₁₋₁₈ alkylthio, C₃₋₁₈ cycloalkyl, aryl, —COOH, —COOC₁₋₁₈ alkyl, (C₁₋₁₈ alkyl)₀₋₁-CO—C₁₋₁₈ alkyl, or SO₃R²; aryl that is optionally substituted by one or more electron withdrawing groups; or the R¹ groups together may form a ring, where R² is H; C₁₋₁₈ alkyl that is optionally substituted by one or more halogen, —CN, —OH, —SH, C₁₋₁₈ akoxy, C₁₋₁₈ alkylthio, C₃₋₁₈ cycloalkyl, aryl, —COOH, —COOC₁₋₁₈ alkyl, (C₁₋₁₈ alkyl)₀₋₁-CO—C₁₋₁₈ alkyl, or —SO₃H; and Ar is aryl that is optionally substituted by one or more electron withdrawing groups. Suitable electron withdrawing groups include —COOH, —COOR², —SO₃R², —CN, —CO—C₁₋₁₈alkyl, and —C(O)H groups.

In formula Ar—N(R¹)—C(H)(R¹)₂, the cycloalkyl group typically has 3 to 6 ring carbon atoms but may have additional alkyl substitutions up to the specified number of carbon atoms. The aryl groups may be carbocyclic or heterocyclic aryl. In some embodiments, the aryl groups are carbocyclic, in some embodiments, phenyl.

Useful aromatic amine donor compounds include 4,4′-bis(diethylamino)benzophenone (BDEAB), 4-dimethylaminobenzoic acid (4-DMABA), ethyl p-dimethylaminobenzoate (EDMAB), 3-dimethylamino benzoic acid (3-DMABA), 4-dimethylaminobenzoin (DMAB), 4-dimethylaminobenzaldehyde (DMABAL), 1,2,4-trimethoxybenzene (TMB), and N-phenylglycine (NPG).

In some embodiments, the electron donor is an aryl alkyl polyether. Suitable aryl alkyl polyethers have aromatic rings substituted by more than one C₁₋₁₈alkoxy group. The alkoxy groups may optionally be substituted by one or more halogen, —CN, —OH, —SH, C₁₋₁₈ akoxy, C₁₋₁₈ alkylthio, C₃₋₁₈ cycloalkyl, aryl, substituted aryl, —COOH, —COOC₁₋₁₈ alkyl, (C₁₋₁₈ alkyl)₀₋₁-COH, (C₁₋₁₈ alkyl)₀₋₁-CO—C₁₋₁₈ alkyl, —CO—C₁₋₁₈ alkyl, —C(O)H, or —C₂₋₁₈-alkenyl groups. In some embodiments, the aryl alkyl polyether is 1,2,4-trimethoxybenzene.

In some embodiments, the electron donor is an anthracene, for example, unsubstituted anthracene, a substituted anthracene, or a combination thereof. The substituted anthracene may be an alkyl or alkoxy substituted anthracene, such as 2-ethyl-9,10-dimethoxyanthracene (EDMOA), 2,6-di-tert-butylanthracene, 9,10-dimethylanthracene, 1,4-dimethoxyanthracene, and 9,10-dimethoxyanthracene. In some embodiments, the electron donor comprises two or more substituted anthracenes, wherein one of the anthracenes is an alkoxy substituted anthracene (e.g., EDMOA) and the other anthracene is an alkyl, phenyl or alkoxy substituted anthracene. In some embodiments, the electron donor comprises a combination of a substituted anthracene such as 2-ethyl-9,10-dimethoxyanthracene, 2,6-di-tert-butylanthracene, or 9,10-dimethylanthracene and unsubstituted anthracene.

The photoinitiator and optionally photosensitizer and aromatic amine electron donor may be present in the composition in an amount effective to initiate or enhance the rate of cure of the resin system. In some embodiments, the photoinitiator that generates acid upon exposure to actinic radiation is present at about 0.05-5.0 weight percent, about 0.10-3.0 weight percent, or about 0.50-2.0 weight percent, based on the total weight of the composition. In some embodiments, the sensitizer is present in about 0.05-3 weight percent or 0.10 to 1.0 weight percent, based on the total weight of the composition. In some embodiments, the aromatic amine donor compound is present at about 0.01 to 5.0 weight percent or 0.05 to 1.0 weight percent, based on the total weight of the composition.

In some embodiments, the composition of the present disclosure includes a second photoinitiator that generates free radicals on exposure to actinic radiation. Examples of useful second photoinitiators include benzoin ethers (e.g., benzoin methyl ether or benzoin butyl ether); acetophenone derivatives (e.g., 2,2-dimethoxy-2-phenylacetophenone or 2,2-diethoxyacetophenone); 1-hydroxycyclohexyl phenyl ketone; and acylphosphine oxide derivatives and acylphosphonate derivatives. Suitable acylphosphine oxides can be characterized by the following formula

(R⁹)₂—P(═O)C(═O)—R¹⁰

wherein each R⁹ individually can be a hydrocarbyl group such as alkyl, cycloalkyl, aryl, and aralkyl, any of which can be substituted with a halo-, alkyl- or alkoxy-group, or the two R⁹ groups can be joined to form a ring along with the phosphorous atom, and wherein R¹⁰ is a hydrocarbyl group, an S—, O—, or N-containing five- or six-membered heterocyclic group, or a —Z—C(═O)—P(═O)—(R⁹)₂ group, wherein Z represents a divalent hydrocarbyl group such as alkylene or phenylene having from 2 to 6 carbon atoms. Many photoinitiators are available, for example, from BASF under the trade designation “IRGACURE”.

Commercially-available phosphine oxide photoinitiators include a 25:75 mixture, by weight, of bis(2,6-dimethoxybenzoyl)-2,4,4-trimethylpentyl phosphine oxide and 2-hydroxy-2methyl-1phenylpropan-1-one available from BASF under the trade designation “IRGACURE 1700”, a 1:1 mixture, by weight, of bis(2,4,6-trimnethylbenzoyl)phenyl phosphine oxide and 2-hydroxy-2-methyl-1-phenylpropane-1-one available from BASF under the trade designation “DAROCUR 4265”, ethyl-2,4,6-trimethylbenzylphenyl phosphinate available from BASF under the trade designation “LUCIRN LR8893X”, and bis(2,4,6-trimethylbenzoyl)phenyl phosphine oxide available from BASF under the trade designation “IRGACURE 819”. In some embodiments, the second photoiniator is bis(2,4,6-trimethylbenzoyl)phenylphosphine oxide, diphenyl-2,4,6-trimethylbenzoylphosphine oxide, isopropoxyphenyl-2,4,6-trimethylbenzoylphosphine oxide, dimethyl pivaloylphosphonate) or a combination thereof.

The photoinitiator may be selected, for example, based on the desired wavelength for curing and compatibility with the polymeric resin desired to be cured. Any useful amount of photoinitiator may be included the composition. In some embodiments, a photoinitiator is included the composition in an amount up to 3, 2.5, 2, or 1 percent by weight, based on the total weight of the composition. In some embodiments, a photoinitiator is included the composition in an amount of at least 0.05, 0.1, or 0.2 percent by weight, based on the total weight of the composition.

In some embodiments, the composition of the present disclosure includes an iniferter. The terms “iniferter” and “photoiniferters” refer to molecules that can act as an initiator, chain transfer agent, and terminator. Various iniferters were discussed in Otsu et al., Makromol. Chem., Rapid Commun., 3, 127-132 (1982). The compound p-xylene bis(N,N-diethyldithiocarbamate) (XDC) has been used to form various acrylic-based block copolymers such as those described in European Patent Applications 0286376 A2 (Otsu et al.) and 0349270 A2 (Mahfuza et al.). Xanthate esters were used as a photoinitiator in U.S. Pat. No. 2,716,633 (Vaughn et al.). In some embodiments, the composition of the present disclosure includes tetraethylthiuram disulfide. In some embodiments, such compounds are included the composition in an amount of at least 0.005, 0.01, or 0.02 percent by weight, or an amount up to 0.2 or 0.15 percent by weight, based on the total weight of the composition.

The composition according to the present disclosure can include a vinyl ester resin. As would be understood by a person of ordinary skill in the art, a vinyl ester is a resin produced by the esterification of an epoxy resin with an unsaturated monocarboxylic acid. Epoxy vinyl ester resins are typically prepared, for example, by reacting a vinyl monocarboxylic acid (e.g., acrylic acid, methacrylic acid, ethacrylic acid, halogenated acrylic or methacrylic acids, cinnamic acid, and combinations thereof) and an aromatic polyepoxide (e.g., a chain-extended diepoxide or novolac epoxy resin having at least two epoxide groups) or a monomeric diepoxide. Useful epoxy vinyl ester resins typically have at least two end groups represented by formula —CH₂—CH(OH)—CH₂—O—C(O)—C(R″)═CH(R′), wherein R″ is hydrogen, methyl, or ethyl, wherein the methyl or ethyl group may optionally be halogenated, wherein R¹ is hydrogen or phenyl, and wherein the terminal CH₂ group is linked directly or indirectly to the aromatic group described below (e.g., through a phenolic ether functional group). The aromatic polyepoxide or aromatic monomeric diepoxide typically contains at least one (in some embodiments, at least 2, in some embodiments, in a range from 1 to 4) aromatic ring that is optionally substituted by a halogen (e.g., fluoro, chloro, bromo, iodo), alkyl having 1 to 4 carbon atoms (e.g., methyl or ethyl), or hydroxyalkyl having 1 to 4 carbon atoms (e.g., hydroxymethyl). For epoxy resins containing two or more aromatic rings, the rings may be connected, for example, by a branched or straight-chain alkylene group having 1 to 4 carbon atoms that may optionally be substituted by halogen (e.g., fluoro, chloro, bromo, iodo).

Examples of aromatic epoxy resins useful for reaction with vinyl monocarboxylic acids include novolac epoxy resins (e.g., phenol novolacs, ortho-, meta-, or para-cresol novolacs or combinations thereof), bisphenol epoxy resins (e.g., bisphenol A, bisphenol F, halogenated bisphenol epoxies, and combinations thereof), resorcinol epoxy resins, and tetrakis phenylolethane epoxy resins. Examples of aromatic monomeric diepoxides useful for reaction with vinyl monocarboxylic acids include the diglycidyl ethers of bisphenol A and bisphenol F and mixtures thereof. In some embodiments, bisphenol epoxy resins, for example, may be chain extended to have any desirable epoxy equivalent weight. In some embodiments, the aromatic epoxy resin (e.g., either a bisphenol epoxy resin or a novolac epoxy resin) may have an epoxy equivalent weight of at least 140, 150, 200, 250, 300, 350, 400, 450, or 500 grams per mole. In some embodiments, the aromatic epoxy resin may have an epoxy equivalent weight of up to 2500, 3000, 3500, 4000, 4500, 5000, 5500, or 6000 grams per mole. In some embodiments, the aromatic epoxy resin may have an epoxy equivalent weight in a range from 150 to 6000, 200 to 6000, 200 to 5000, 200 to 4000, 250 to 5000, 250 to 4000, 300 to 6000, 300 to 5000, or 300 to 3000 grams per mole.

Several aromatic epoxy vinyl ester resins useful for the composition of the present disclosure are commercially available. For example, epoxy diacrylates such as bisphenol A epoxy diacrylates and epoxy diacrylates diluted with other acrylates are commercially available, for example, from Cytec Industries, Inc., Smyrna, Ga., under the trade designation “EBECRYL”. Aromatic epoxy vinyl ester resins such as novolac epoxy vinyl ester resins diluted with styrene are available, for example, from Ashland, Inc., Covington, Ky., under the trade designation “DERAKANE” (e.g., “DERAKANE 470-300”) and from Interplastic Corporation, St. Paul, Minn., under the trade designation “CoREZYN” (e.g., “CoREZYN 8730” and “CoREZYN 8770”).

The composition according to the present disclosure and/or useful for practicing the present disclosure can include up to 15, 10, or five percent by weight of a reactive diluent having a flash point up to 150° C. The composition according to the present disclosure and/or useful for practicing the present disclosure can include up to 4, 3, 2, 1, 0.5, 0.25, or 0.1 percent by weight of a reactive diluent having a flash point up to 150° C. The composition according to the present disclosure and/or useful for practicing the present disclosure can also be free of reactive diluent having a flash point up to 150° C.

Some common reactive diluents having a flash point up to 150° C. are vinyl aromatic compounds having at least one vinyl substituent on an aromatic ring, typically a benzene ring or a naphthalene ring. In addition to the vinyl substituent, the vinyl aromatic compound may also include other substituents (e.g., alkyl, alkoxy, or halogen). Examples of such vinyl aromatic compounds include styrene, alpha-methyl styrene, p-methyl styrene, p-tert-butyl styrene, chlorostyrene, dichlorostyrene, p-ethoxystyrene, p-propoxystyrene, divinyl benzene, and vinyl naphthalene. Advantageously, the composition of the present disclosure can be free of styrene and other vinyl aromatic compounds.

Reactive diluents also include vinyl ethers such as ethyl vinyl ether, n-propyl vinyl ether, isopropyl vinyl ether, n-butyl vinyl ether, iso-butyl vinyl ether, cyclohexyl vinyl ether, hydroxybutyl vinyl ether, cyclohexanedimethanol divinyl ether, triethyleneglycol divinyl ether, butanediol divinyl ether, cyclohexanedimethanol monovinyl ether, diethyleneglycol divinyl ether, 2-ethylhexyl vinyl ether, dodecyl vinyl ether, octadecyl vinyl ether, hexanediol divinyl ether, dipropyleneglycol divinyl ether, and tripropyleneglycol divinyl ether. Reactive diluents can also include acrylate and methacrylates such as methyl (meth)acrylate, ethyl (meth)acrylate, isopropyl (meth)acrylate, n-butyl (meth)acrylate, isobutyl (meth)acrylate, 2-ethylhexyl (meth)acrylate, lauryl (meth)acrylate, ethylene glycol dicyclopentenyl ether (meth)acrylate, and propanediol dicyclopentenyl ether (meth)acrylate. Hydroxy-functionalized (meth)acrylates that can be used as reactive diluents include hydroxyethyl methacrylate, hydroxypropyl methacrylate, hydroxyethyl acrylate, and hydroxypropyl acrylate. Multifunctional (meth)acrylate monomers that can be used as reactive diluents include 1,4-butanediol diacrylate, 1,6-hexanediol diacrylate, diethylene glycol diacrylate, 1,3-butylene glycol diacrylate, neopentyl glycol diacrylate, cyclohexane dimethanol diacrylate, dipropylene glycoldiacrylate, ethoxylated bisphenol A diacrylate, trimethylolpropane triacrylate, pentaerythritol triacrylate, pentaerythritol tetraacrylate and their related (meth)acrylate derivatives. These reactive diluents have flash points up to 150° C. In some cases, these reactive diluents have flash points up to 125° C., 100° C., or 80° C. The composition according to the present disclosure and/or useful for practicing the present disclosure can include up to 5, 4, 3, 2, 1, 0.5, 0.25, or 0.1 percent by weight of any of these reactive diluents or can be free of any of these reactive diluents. In some embodiments, the composition according to the present disclosure and/or useful for practicing the present disclosure can include up to 5, 4, 3, 2, 1, 0.5, 0.25, or 0.1 percent by weight of triethylene glycol divinyl ether or can be free of triethylene glycol divinyl ether. In some embodiments, the composition according to the present disclosure and/or useful for practicing the present disclosure can include up to 5, 4, 3, 2, 1, 0.5, 0.25, or 0.1 percent by weight of any vinyl ether or can be free of vinyl ethers. In some embodiments, the composition according to the present disclosure and/or useful for practicing the present disclosure can include up to 5, 4, 3, 2, 1, 0.5, 0.25, or 0.1 percent by weight of any acrylate or methacrylate or can be free of acrylates and methacrylates. These percentages are based on the total weight of the composition.

The composition according to the present disclosure and/or useful for practicing the present disclosure can include up to 15 percent by weight of volatile organic compounds (VOCs). A VOC generally has at least one of a vapor pressure of greater than 0.1 mm Hg at 20° C. or a boiling point of less than 216° C. In some embodiments, a VOC has a vapor pressure of greater than 0.05 mm Hg at 20° C. or 0.02 mm Hg at 20° C. In some embodiments, a VOC has a boiling point of less than 200° C. or less than 185° C. VOCs can include the reactive diluents described above and solvents such as those not listed as “exempt” or otherwise excluded in the California Consumer Products Regulations, Subchapter 8.5, Article 2, 94508, last amended Sep. 17, 2014 (Register 2014, No. 38). The composition according to the present disclosure and/or useful for practicing the present disclosure can include up to 14, 13, 12, 10, 9, 8, 7, 6, 5, 4, 3, 2, 1, 0.5, 0.25, or 0.1 percent by weight of any of these VOCs or can be free of any of these VOCs. These percentages are based on the total weight of the composition.

In some embodiments, the composition of the present disclosure includes further reactive compounds having a flash point of greater than 150° C. Useful reactive groups include carbon-carbon double bonds (e.g., acrylates or methacrylates). Reactive compounds having a flash point of greater than 150° C. and one or more carbon-carbon double bonds include methacrylated fatty acids, such as those available, for example, from Croda Inc. Edison, N.J. or those available under the trade designation “MC818” from Dixie Chemical Company, Inc, Pasadena, Tex. Such compounds can also be prepared, for example, by the methods described in U.S. Pat. No. 8,372,926 (Palmese et al.).

In some embodiments, the composition of the present disclosure includes urethane multifunctional (meth)acrylates. Suitable urethane multifunctional (meth)acrylates include oligomers and prepolymers comprising aliphatic urethane multifunctional (meth)acrylates and aromatic urethane multifunctional (meth)acrylates. In some embodiments, the urethane multifunctional (meth)acrylates are selected from urethane di(meth)acrylates, urethane tri(meth)acrylates, urethane tetra(meth)acrylates and combinations thereof. In some embodiments, the urethane multifunctional (meth)acrylate is a di(meth)acrylate. The term “multifunctional (meth)acrylate” as used herein means an oligomer or polymer containing two or more (meth)acryloyloxy groups.

Suitable urethane (meth)acrylates are can be made by reacting polyols with polyisocyanates to form urethane moieties and terminating the urethane moieties with multifunctional (meth)acrylates. In some embodiments, the urethane multifunctional (meth)acrylate is a urethane di(meth)acrylate comprising a carbocyclic aromatic group or a hydrocarbon group with at least four carbon atoms. In other embodiments, the urethane multifunctional (meth)acrylate is a urethane di(meth)acrylate comprising polytetramethylene oxide or polypropylene oxide. In some embodiments, the urethane multifunctional (meth)acrylate comprises a polyester, a polypropylene oxide, or polytetramethylene oxide backbone. In some embodiments, polyethylene oxide backbones were found to be less favorable. In some embodiments, the urethane multifunctional (meth)acrylate is relatively hydrophobic.

Suitable aromatic urethane multifunctional (meth)acrylates can be derived from the reaction product of a polyol, an aromatic diisocyanate (e.g., toluene diisocyanate), and a hydroxyalkyl (meth)acrylate (e.g., hydroxyethyl (meth)acrylate and hydroxypropyl (meth)acrylate). Examples of useful polyols include polyether polyols, polyester polyols, polylactone polyols, polysiloxane polyols, poly(alkylacrylate) polyols, and poly(glycidyl ether) polyols.

Suitable aliphatic urethane multifunctional (meth)acrylates can be derived from the reaction product of polyether polyols (e.g., hydroxyl terminated polypropylene oxide or hydroxyl terminated polytetramethylene oxide), aliphatic diisocyanates (e.g., isophorone diisocyanate), and a hydroxyalkyl (meth)acrylate (e.g., hydroxylethyl (meth)acrylate or hydroxypropyl (meth)acrylate). Suitable aliphatic urethane multifunctional (meth)acrylates also include an aliphatic urethane multifunctional (meth)acrylate having a polycaprolactone backbone. For example, a hydroxylethyl (meth)acrylate ring opens the caprolactone forming a mono-alcohol that is reacted with isophorone diisocyanate, resulting hydrophobic aliphatic urethane di(meth)acrylate.

Commercially available urethane multifunctional (meth)acrylates include those from Allnex (Germany) under the trade designation EBECRYL and designations 244, 264, 265, 1290, 4833, 4883, 8210, 8311, 8402, 8405, 8807, 5129, and 8411; those available from Sartomer under the designations, CN 973H85, CN 985B88, CN 964, CN 944B85, CN 963B80, CN 973J75, CN 973H85, CN 929, CN 996, CN 966J75, CN 968, CN 980, CN 981, CN 982B88, CN 982B90, CN 983, CN991, CN 2920, CN 2921, CN 2922, CN 9001, CN 9005, CN 9006, CN 9007, CN 9009, CN 9010, CN 9031, CN 9782; GENOMER 4212, 4215, 4217, 4230, 4256, 4267, 4269, 4302, and 4316 and UA 00-022 available from Rahn; PHOTOMER 6892 and 6008 available from Cognis; and NK OLIGO U24A and U-15HA available from Kowa. Additional urethane multifunctional (meth)acrylates include the BR series of aliphatic urethane (meth)acrylates such as BR 144 or 970 available from Bomar Specialties or the LAROMER series of aliphatic urethane (meth)acrylates such as LAROMER LR 8987 from BASF.

Commercially available urethane multifunctional (meth)acrylates for use in the curable compositions include those known by the trade designations: PHOTOMER (for example, PHOTOMER 6010 from Henkel Corp., Hoboken, N.J.); EBECRYL (for example, EBECRYL 220 (a hexafunctional aromatic urethane acrylate of molecular weight 1000), EBECRYL 284 (aliphatic urethane diacrylate of 1200 grams/mole molecular weight diluted with 1,6-hexanediol diacrylate), EBECRYL 4827 (aromatic urethane diacrylate of 1600 grams/mole molecular weight), EBECRYL 4830 (aliphatic urethane diacrylate of 1200 grams/mole molecular weight diluted with tetraethylene glycol diacrylate), EBECRYL 6602 (trifunctional aromatic urethane acrylate of 1300 grams/mole molecular weight diluted with trimethylolpropane ethoxy triacrylate), and EBECRYL 840 (aliphatic urethane diacrylate of 1000 grams/mole molecular weight)) from Allnex (Germany); SARTOMER (for example, SARTOMER 9635, 9645, 9655, 963-B80, and 966-A80) from Sartomer Co., West Chester, Pa.; and UVITHANE (for example, UVITHANE 782) from Morton International, Chicago, Ill.

Commercially available aliphatic urethane multifunctional (meth)acrylates include those available from Soltech Ltd., Kyoungnam, Korea, such as SU 500 (aliphatic urethane diacrylate with isobornyl acrylate), SU 5020 (hexa-functional aliphatic urethane acrylate oligomer with 26% butyl acetate), SU 5030 (hexa-functional aliphatic urethane acrylate oligomer with 31% butyl acetate), SU 5039 (nona(9)-functional aliphatic urethane acrylate oligomer), SU 511 (aliphatic urethane diacrylate), SU 512 (aliphatic urethane diacrylate), SU 514 (aliphatic urethane diacrylate with hexane diol diacrylate (HDDA)), SU 591 (aliphatic urethane triacrylate with N-(2-hydroxypropyl) methacrylamide), SU 520 (deca(10)-functional aliphatic urethane acrylate), SU 522 (hexa-functional aliphatic urethane acrylate), SU 5225 (aliphatic urethane diacrylate with isobornyl acrylate), SU 522B (hexa-functional aliphatic urethane acrylate), SU 5260 (aliphatic urethane triacrylate), SU 5270 (aliphatic urethane diacrylate), SU 530 (aliphatic urethane diacrylate), SU 5347 (aliphatic urethane diacrylate), SU 542 (low viscosity aliphatic urethane diacrylate), SU 543 (low viscosity aliphatic urethane diacrylate), SU 564 (aliphatic urethane triacrylate with HDDA), SU 565 (aliphatic urethane triacrylate with tripropylene glycol diacrylate), SU 570 (aliphatic urethane diacrylate), SU 571 (hexa functional aliphatic urethane diacrylate), SU 574 (aliphatic urethane triacrylate with HDDA), SU 574B (aliphatic urethane triacrylate with HDDA), SU 580 (aliphatic urethane diacrylate), SU 584 (aliphatic urethane triacrylate with HDDA), SU 588 (aliphatic urethane triacrylate with 2-(2-ethoxyethoxy)ethyl acrylate), and SU 594 (aliphatic urethane triacrylate with HDDA).

Commercially available aromatic urethane multifunctional (meth)acrylates include those available from Soltech Ltd., Kyoungnam, Korea, such as SU 704 (aromatic urethane triacrylate with HDDA), SU 710 (aromatic urethane diacrylate), SU 720 (hexa-functional aromatic urethane acrylate), and SU 7206 (aromatic urethane triacrylate with trimethylolpropane triacrylate).

In some embodiments, the urethane multifunctional (meth)acrylate has a number average molecular weight of 900 to 20,000 grams/mole as measured using Gel Permeation Chromatography (GPC). In some embodiments, the urethane multifunctional (meth)acrylate has a number average molecular weight of 3,000 to 20,000 grams/mole or 5,000 to 20,000 grams/mole as measured using GPC. Compositions according to the present disclosure typically include the one or more reactive compounds having a flash point of at least 150° C. and/or the urethane multifunctional acrylate in an amount of up to 40% by weight based on the total weight of the composition. In some embodiments, the composition according to the present disclosure includes the urethane multifunctional acrylate in an amount in a range from 1% by weight to 40% by weight, 2% by weight to 30% by weight, 2% by weight to 20% by weight, or 5% by weight to 20% by weight based on the total weight of the composition.

In some embodiments, the composition according to and/or useful for practicing the present disclosure includes a wax, which may be useful, for example, for reducing tackiness at the surface as the composition cures. Useful waxes include a wide variety of paraffins. Examples of useful waxes include those from Frank B. Ross Co., Rahway, N.J. In some embodiments, the wax is present in an amount in a range from 0.05 weight percent to about 2 weight percent (in some embodiments, 0.05 weight percent to 1 weight percent, or 0.1 weight percent to 0.5 weight percent), based on the total weight of the composition.

The composition according to the present disclosure and/or useful for practicing the present disclosure can include one or more radical inhibitors. Examples of useful classes of radical inhibitors include phenolic compounds, stable radicals like galvinoxyl and N-oxyl based compounds, catechols, and phenothiazines. Examples of useful radical inhibitors that can be used in composition according to the present disclosure include 2-methoxyphenol, 4-methoxyphenol, 2,6-di-t-butyl-4-methylphenol, 2,6-di-t-butylphenol, 2,4,6-trimethyl-phenol, 2,4,6-tris-dimethylaminomethyl phenol, 4,4′-thio-bis(3-methyl-6-t-butylphenol), 4,4′-isopropylidene diphenol, 2,4-di-t-butylphenol, 6,6′-di-t-butyl-2,2′-methylene di-p-cresol, hydroquinone, 2-methylhydroquinone, 2-t-butylhydroquinone, 2,5-di-t-butylhydroquinone, 2,6-di-t-butylhydroquinone, 2,6-dimethylhydroquinone, 2,3,5-trimethylhydroquinone, catechol, 4-t-butylcatechol, 4,6-di-t-butylcatechol, benzoquinone, 2,3,5,6-tetrachloro-1,4-benzoquinone, methylbenzoquinone, 2,6-dimethylbenzoquinone, naphthoquinone, 1-oxyl-2,2,6,6-tetramethylpiperidine, 1-oxyl-2,2,6,6-tetramethylpiperidine-4-ol, 1-oxyl-2,2,6,6-tetramethylpiperidine-4-one, 1-oxyl-2,2,6,6-tetramethyl-4-carboxyl-piperidine, 1-oxyl-2,2,5,5-tetramethylpyrrolidine, 1-oxyl-2,2,5,5-tetramethyl-3-carboxylpyrrolidine, aluminium-N-nitrosophenyl hydroxylamine, diethylhydroxylamine, phenothiazine and/or derivatives or combinations of any of these compounds. Any useful amount of radical inhibitor may be included in the composition disclosed herein. In some embodiments, the amount of radical inhibitor in the composition according to the present disclosure is in the range of from 0.0001% to 5% (in some embodiments, 0.001% to 0.5%) by weight, based on the total weight of the composition.

The composition according to the present disclosure may also include a filler. In some embodiments, the composition according to the present disclosure includes at least one of ceramic beads, polymer beads, silica, hollow ceramic elements, hollow polymeric elements, alumina, zirconia, mica, dolomite, wollastonite, fibers, talc, calcium carbonate, sodium metaborate, or clay. Such fillers, alone or in combination, can be present in the composition according to the present disclosure in a range from 10 percent by weight to 70 percent by weight, in some embodiments, 20 percent by weight to 60 percent by weight or 40 percent by weight to 60 percent by weight, based on the total weight of the composition. Silica, alumina, and zirconia, for example, can be of any desired size, including particles having an average size above 1 micrometer, between 100 nanometers and 1 micrometer, and below 100 nanometers. Silica can include nanosilica and amorphous fumed silica, for example. The term “ceramic” refers to glasses, crystalline ceramics, glass-ceramics, and combinations thereof. Hollow ceramic elements can include hollow spheres and spheroids. Examples of commercially available materials suitable for use as the hollow, ceramic elements include glass bubbles marketed by 3M Company, Saint Paul, Minn., as “3M GLASS BUBBLES” in grades K1, K15, K20, K25, K37, K46, S15, S22, S32, S35, S38, S38HS, S38XHS, S42HS, S42XHS, S60, S60HS, iM30K, iM16K, XLD3000, XLD6000, and G-65, and any of the HGS series of “3M GLASS BUBBLES”; glass bubbles marketed by Potters Industries, Carlstadt, N.J., under the trade designations “Q-CEL HOLLOW SPHERES” (e.g., grades 30, 6014, 6019, 6028, 6036, 6042, 6048, 5019, 5023, and 5028); and hollow glass particles marketed by Silbrico Corp., Hodgkins, Ill. under the trade designation “SIL-CELL” (e.g., grades SIL 35/34, SIL-32, SIL-42, and SIL-43). The hollow, ceramic elements may also be made from ceramics such as alpha-alumina, zirconia, and alumina silicates. In some embodiments, the hollow, ceramic elements are aluminosilicate microspheres extracted from pulverized fuel ash collected from coal-fired power stations (i.e., cenospheres). Useful cenospheres include those marketed by Sphere One, Inc., Chattanooga, Tenn., under the trade designation “EXTENDOSPHERES HOLLOW SPHERES” (e . . . grades SG, MG, CG, TG, HA, SLG, SL-150, 300/600, 350 and FM-1). Other useful hollow, ceramic spheroids include silica-alumina ceramic hollow spheres with thick walls marketed by Valentine Chemicals of Lockport, La., as ZEEOSPHERES CERAMIC MICROSPHERES in grades N-200, N-200PC, N-400, N-600, N-800, N1000, and N1200. The hollow ceramic elements may have one of a variety of useful sizes but typically has a maximum dimension, or average diameter, of less than 10 millimeters (mm), more typically less than one mm. In some embodiments, the hollow ceramic elements have a maximum dimension in a range from 0.1 micrometer to one mm, from one micrometer to 500 micrometers, from one micrometer to 300 micrometers, or even from one micrometer to 100 micrometers. The mean particle size of the hollow, ceramic elements may be, for example, in a range from 5 to 250 micrometers (in some embodiments from 10 to 110 micrometers, from 10 to 70 micrometers, or even from 20 to 40 micrometers). As used herein, the term size is considered to be equivalent with the diameter and height, for example, of glass bubbles. In some embodiments, each of the fillers in the composition according to the present disclosure has a mean particle size up to 100 micrometers as described in U.S. Pat. No. 8,034,852 (Janssen et al.). Compositions according to the present disclosure can also include dyes, pigments, rheology modifiers (e.g., fumed silica or clay).

Compositions according to the present disclosure can be packaged, for example, as a one-part composition if desired. One application of compositions according to the present disclosure are curable body repair materials useful in the repair of damaged vehicles and other equipment (e.g., cars, trucks, watercraft, windmill blades, aircraft, recreational vehicles, bathtubs, storage containers, and pipelines).

The present disclosure provides a method of repairing a damaged surface. The method includes applying the composition described above in any of its embodiments to the damaged surface and exposing the composition on the damaged surface to actinic radiation to cure the composition.

The present disclosure provides a cured composition made from the curable composition according to any of the above embodiments as well as an article comprising the cured composition on a surface.

In some embodiments of the method of the present disclosure, the damaged surface to be repaired is on at least a portion of a vehicle. Similarly, in some embodiments of the article of the present disclosure, the article is a portion of a vehicle.

The process of repairing dents and other damage using body repair materials can present challenges. For repairing an automobile, for example, a technician typically mixes two reactive components and then uses a squeegee to spread the repair compound onto the surface of the vehicle to roughly match the contour of the surface. As the curable polymeric resin reacts with the curative or initiator, it hardens to a state where it can be shaped to match the contour of the vehicle before it was damaged. During this hardening process, the repair compound typically transitions from a state of soft, gelled material to a state of moderately hard material that is relatively easy to shape with an abrasive article (e.g., sandpaper) to a state of hard material. Body repair materials typically require handling in a relatively narrow time window. Premature sanding of body repair material before it has reached a critical amount of cure results in sandpaper becoming plugged reducing its effectiveness, the surface of the body repair material becoming rough, and sometimes the body repair material peeling away from the surface of the vehicle. If this situation occurs, then typically the body repair material has to be partially removed (usually by sanding) such that another layer of body repair material can be put on top and properly shaped. Furthermore, it is challenging for body repair materials to adhere well to a variety of common repair surfaces (e.g., aluminum, galvanized steel, E-coats, primers, and paints).

Multifunctional acrylate and methacrylate monomers are widely used in coating applications. When photochemically cured in air, these materials undergo radical polymerization, but the problem of oxygen inhibition is common and results in a tacky surface. A relatively high intensity radiation source can be useful for reducing surface tackiness, but the high-intensity radiation may result in a high degree of shrinkage and stress leading to decreased adhesion on the subtract, especially 180 degree bending adhesion described in the Examples below. See, for example, Comparative Examples 10 and 11, which can provide relatively low surface tackiness but fail to provide good bending adhesion.

The composition according to the present disclosure has multiple advantages as a body repair composition. The composition is useful as a one-part composition and therefore can be uses directly from the container without having to mix two components before applying. The composition remains workable for a long period of time in shaded areas. Typically, and advantageously, when the composition is exposed to an actinic radiation source, it can be cured in two minutes or less, or typically, in one minute or less. In many embodiments, the composition quickly develops adhesion to a surface (e.g., aluminum, galvanized steel, composite, E-coats, primers, and paints) to which it is applied. The cured composition has low shrinkage and stress buildup as evidenced by the 180-degree bending adhesion for Examples 1 to 9, below. The composition can be cured by wide range of light sources. Upon generation of the acid with the exposure to actinic radiation, the cure of the composition can continue to progress even in the absence of further irradiation.

It can be useful to package the composition of the present disclosure in a container that protects it from premature exposure to light. A variety of methods can be used to apply the composition to a surface (e.g., brushing, spraying, bar coating, wiping, rolling, or spreading).

Any suitable device emitting electromagnetic radiation and having a radiometric energy of about at least 0.1 W/cm² can be used to cure the compositions of the various embodiments described herein. In some embodiments, a suitable light-emitting curing device has a radiometric energy from 0.1-5 W/cm², 0.1-3 W/cm², or 0.1-2 W/cm².

When curing the composition, the light source and exposure time can be selected, for example, based on the nature and amount of the composition. Sources of ultraviolet and/or visible light can be useful (for example, wavelengths ranging from about from about 200 nm to about 700 nm, 200 nm to about 650 nm, from about 315 nm to 550 nm, or from about 315 nm to 500 nm can be useful). Suitable light includes sunlight and light from artificial sources, including both point sources and flat radiators. In some embodiments, the light source is a source of at least one of UVA or blue light. In some embodiments, the light source is a blue light source. Examples of useful light sources include carbon arc lamps; xenon arc lamps; medium-pressure, high-pressure, and low-pressure mercury lamps, doped if desired with metal halides (metal halogen lamps); microwave-stimulated metal vapor lamps; excimer lamps; superactinic fluorescent tubes; fluorescent lamps; incandescent argon lamps; electronic flashlights; xenon flashlights; photographic flood lamps; light-emitting diodes (LED); laser light sources (for example, excimer lasers); and combinations thereof. The distance between the light source and the composition to be cured can vary widely, depending upon the particular application and the type and/or power of the light source. For example, distances up to about 150 cm, distances from about 0.01 cm to 150 cm, or a distance as close as possible without touching the composition can be useful.

In some embodiments, the method of repairing a damaged surface of the present disclosure further comprises at least one of shaping or sanding the cured composition on the surface. The method can also include providing at least one of a coating or finish over the cured composition.

### Some Embodiments of the Disclosure

In a first embodiment, the present disclosure provides a composition comprising:

a polyester resin comprising at least one α,β-unsaturated ester group;

an epoxy resin;

a compound comprising at least one hydroxyl group; and

a photoinitiator that generates acid upon exposure to actinic radiation.

In a second embodiment, the present disclosure provides the composition of the first embodiment, wherein the photoinitiator generates both acid and free radicals upon exposure to actinic radiation.

In a third embodiment, the present disclosure provides the composition of the first or second embodiment, wherein the polyester resin comprises a dicyclopentadiene-modified unsaturated polyester resin.

In a fourth embodiment, the present disclosure provides the composition of the third embodiment, wherein the polyester resin comprises a dicyclopentenyl-end-capped unsaturated polyester resin.

In a fifth embodiment, the present disclosure provides the composition of any one of the first to fourth embodiments, further comprising a photosensitizer.

In a sixth embodiment, the present disclosure provides the composition of the fifth embodiment, wherein the photosensitizer is a visible-light photosensitizer.

In a seventh embodiment, the present disclosure provides the composition of the fifth or sixth embodiment, wherein the photosensitizer comprises at least one of a ketone, coumarin dye, xanthene dye, acridine dye, thiazole dye, thiazine dye, oxazine dye, azine dye, aminoketone dye, porphyrin, aromatic polycyclic hydrocarbon, p-substituted aminostyryl ketone compound, aminotriaryl methane, merocyanine, squarylium dye, or pyridinium dye.

In an eighth embodiment, the present disclosure provides the composition of the seventh embodiment, wherein the photosensitizer comprises at least one of a diketone (e.g., α-diketone), ketocoumarin, aminoarylketone, or p-substituted aminostyryl ketone. In some of these embodiments, the photosensitizer comprises camphorquinone.

In a ninth embodiment, the present disclosure provides the composition of any one of the first to eighth embodiments, further comprising an electron donor.

In a tenth embodiment, the present disclosure provides the composition of the ninth embodiment, wherein the aromatic amine electron donor comprises at least one of 4,4′bis(diethylamino)benzophenone, 4-dimethylaminobenzoic acid, ethyl p-dimethylaminobenzoate, 3-dimethylaminobenzoic acid, 4-dimethylaminobenzoin, 4-dimethylaminobenzaldehyde, N-phenylglycine, 1,2,4-trimethoxybenzene, anthracene, or a substituted anthracene.

In an eleventh embodiment, the present disclosure provides the composition of the tenth embodiment, wherein the aromatic amine electron donor comprises ethyl p-dimethylaminobenzoate.

In a twelfth embodiment, the present disclosure provides the composition of any one of the first to eleventh embodiments, wherein the photoinitiator that generates acid on exposure to actinic radiation comprises at least one of an aromatic sulfonium salt or an aromatic iododium salt.

In a thirteenth embodiment, the present disclosure provides the composition of the twelfth embodiment, wherein the photoinitiator is diphenyliodonium hexafluorophosphate.

In a fourteenth embodiment, the present disclosure provides the composition of any one of the first to thirteenth embodiment, further comprising a second photoinitiator.

In a fifteenth embodiment, the present disclosure provides the composition of the fourteenth embodiment, wherein the second photoinitiator is an acyl phosphine oxide.

In a sixteenth embodiment, the present disclosure provides the composition of the fifteenth embodiment, wherein the second photoinitiator is bis(2,4,6-trimethylbenzoyl)-phenylphosphineoxide.

In a seventeenth embodiment, the present disclosure provides the composition of any one of the first to sixteenth embodiments, further comprising a urethane multifunctional acrylate or methacrylate.

In an eighteenth embodiment, the present disclosure provides the composition of any one of the first to the seventeenth embodiments, wherein the compound comprising at least one hydroxyl group is a polyol.

In a nineteenth embodiment, the present disclosure provides the composition of the eighteenth embodiment, wherein the polyol comprises at least one of 1,2-ethanediol, 1,2-propanediol, 1,3-propanediol, 1,4-butanediol, 1,3-butanediol, 2-methyl-1,3-propanediol, 2,2-dimethyl-1,3-propanediol, 2-ethyl-1,6-hexanediol, 1,5-pentanediol, 1,6-hexanediol, 1,8-octanediol, neopentyl glycol, glycerol, trimethylolpropane, 1,2,6-hexanetriol, trimethylolethane, pentaerythritol, quinitol, mannitol, sorbitol, diethylene glycol, triethylene glycol, tetraethylene glycol, glycerine, 2-ethyl-2-(hydroxymethyl)-1,3-propanediol, 2-ethyl-1,3-pentanediol, 1,4-cyclohexanedimethanol, or 1,4-benzene-dimethanol. In a twentieth embodiment, the present disclosure provides the composition of any one of the first to nineteenth embodiments, wherein the epoxy resin is an aromatic epoxy resin.

In a twenty-first embodiment, the present disclosure provides the composition of the twentieth embodiment, wherein the aromatic epoxy resin is a bisphenol epoxy resin.

In a twenty-second embodiment, the present disclosure provides the composition of any one of the first to twenty-first embodiments, further comprising at least one of ceramic beads, polymer beads, silica, hollow ceramic elements, hollow polymeric elements, alumina, zirconia, mica, dolomite, wollastonite, fibers, talc, calcium carbonate, or clay.

In a twenty-third embodiment, the present disclosure provides the composition of any one of the first to twenty-second embodiments, further comprising a reactive diluent comprising at least one of an acrylate group, a methacrylate group, a vinyl ether group, a vinyl ester group, or an allyl ether group.

In a twenty-fourth embodiment, the present disclosure provides the composition of any one of the first to twenty-third embodiments, wherein the composition comprises up to 15 percent by weight of volatile organic compounds, up to 10 percent volatile organic compounds, or up to 5 percent volatile organic compounds.

In a twenty-fifth embodiment, the present disclosure provides the composition of the twenty-third or twenty-fourth embodiment, wherein the reactive diluent or volatile organic compounds have a flash point up to 100° C.

In a twenty-sixth embodiment, the present disclosure provides the composition of any one of the first to twenty-fifth embodiments, further comprising one or more reactive compounds having a flash point of greater than 150° C. and having at least one of an acrylate or methacrylate group.

In a twenty-seventh embodiment, the present disclosure provides the composition of any one of the first to twenty-sixth embodiments, wherein the composition is free of vinyl ethers.

In a twenty-eighth embodiment, the present disclosure provides the composition of any one of the first to twenty-seventh embodiments, wherein the composition is free of styrene and/or vinyl aromatic compounds.

In a twenty-ninth embodiment, the present disclosure provides a method of repairing a damaged surface, the method comprising:

applying the composition of any one of the first to twenty-eighth embodiments to the damaged surface; and

exposing the composition on the damaged surface to actinic radiation to cure the composition.

In a thirtieth embodiment, the present disclosure provides the method of the twenty-ninth embodiment, wherein the damaged surface is on at least a portion of a vehicle.

In a thirty-first embodiment, the present disclosure provides the method of the twenty-ninth or thirtieth embodiment, wherein the actinic radiation is visible light.

In a thirty-second embodiment, the present disclosure provides the method ofany one of the twenty-ninth to thirty-first embodiments, wherein the actinic radiation is blue light.

In a thirty-third embodiment, the present disclosure provides an article prepared by curing the composition of any one of the first to twenty-eighth embodiments or prepared by the method ofany one of the twenty-ninth to thirty-second embodiments.

In order that this disclosure can be more fully understood, the following examples are set forth. It should be understood that these examples are for illustrative purposes only and are not to be construed as limiting this disclosure in any manner.

EXAMPLES
Materials

| Abbreviation or Trade Name | Description |
|---|---|
| AGE | Allyl glycidyl ether, obtained from obtained from |
| | MilliporeSigma Company, St. Louis, Missouri. |
| IRGACURE 819 | Bis(2,4,6-trimethylbenzoyl)-phenylphosphineoxide, |
| | photoinitiator, obtained under the trade designation |
| | “IRGACURE 819” from BASF Corporation, Charlotte, North |
| | Carolina. |
| Camphorquinone | Obtained from MilliporeSigma Company. |
| CN973 | An aromatic polyester based urethane diacrylate oligomer, |
| | obtained under the trade designation “CN973H85” from |
| | Sartomer USA, LLC., Eaton, Pennsylvania. |
| DPIHFP | Diphenyliodonium hexafluorophosphate, obtained from |
| | MilliporeSigma Company. |
| DVE-2 | Diethyleneglycoldivinyl ether, obtained under the trade |
| | designation “DVE-2” from BASF Corporation, Florham Park, |
| | New Jersey. |
| EDMAB | Ethyl 4-N,N-Dimethylaminobenzoate, obtained from |
| | MilliporeSigma Company. |
| EG | Ethylene glycol, obtained from VWR International, LLC, |
| | Radnor, Pennsylvania. |
| EPON 828 | An undiluted clear difunctional bisphenol A/epichlorohydrin |
| | derived liquid epoxy resin, obtained under the trade |
| | designation “EPON Resin 828” from Hexion, Inc., Stafford, |
| | Tex.. |
| HEMA | 2-Hydroxyethyl methacrylate, obtained from Degussa Corp., |
| | Piscataway, New Jersey. |
| Minex | Sodium-potassium alumina silicate produced from nepheline |
| | syenite, obtained under the trade designation “Minex 10” |
| | from Unimin Corp., Spruce Pine, North Carolina. |
| MTBHQ | Mono-Tert-Butylhydroquinone, obtained from Plasticolors, |
| | Inc., Ashtabula, Ohio. |
| PW | Paraffin wax, having a melting point of 125° F.-130° F., obtained |
| | under the trade designation “60-0254” from Frank B. Ross |
| | Co. Inc., Rahway, New Jersey. |
| K-20 | Glass bubbles, obtained under the trade designation “K-20” |
| | from 3M Company. St. Paul, Minnesota. |
| SDCP | A Dicyclopentadiene terminated polyester resin, obtained |
| | from Polynt Composites USA Inc., North Kansas City, |
| | Missouri, as specialty materials without trade designation. |
| SR351H | Trimethylolpropane triacrylate, obtained under the trade |
| | designation “SR351H” from Sartomer USA, LLC., Eaton, |
| | Pennsylvania. |
| TETDS | Tetraethylthiuram disulfide, obtained from MilliporeSigma |
| VHR | A vinyl hybrid liquid resin obtained under the trade |
| | designation “D35065” from Reichhold LLC, Durham, North |
| | Carolina. |
| VV9 | A vinyl ester of VersaticTM Acid 9, obtained under the trade |
| | designation “VeoVa 9 Monomer” from Hexion, Inc. Stafford, |
| | Texas. |
| #10 White | Calcium carbonate, obtained under the trade designation “#10 |
| | White” from Imerys Co, Roswell, Georgia. |
| ZEOTHIX | Amorphous silica, obtained under the trade designation |
| | “ZEOTHIX 265” from Huber Engineered Materials Co, |
| | Overland Park, Kansas. |

### Panel Preparation and Test Methods

### Panel Preparation:

A 210 mm by 100 mm steel panel was manually sanded with an 80-grit sandpaper to provide a rough surface. The surface was cleaned using acetone. Formulations in accordance with Table 1 and 2 were applied to panel, as prepared above, using a putty knife, to give a smooth layer having at thickness of about 2 mm. Each panel was irradiated using a blue LED light with measured output of 2 W/cm², as measured at 400 nm-500 nm with an Opsytec De. Grobel UV PAD 260-500 nm high power sensor, for 50 seconds at a distance of approximately 1 inch (2.54 cm). After 5 minutes, the cured formulation was evaluated for its surface curing by measuring surface tackiness, sanding, degree of clogging, featheredging, scratching resistance, and bending adhesion. The results of the evaluations are shown in Table 3.

### Surface Tackiness Test Method:

Surface tackiness is a measure of surface curing of the formulation and was determined by applying a gloved fingertip to the surface of a cured formulation and monitoring for the presence of stickiness/tackiness. Tack Free is when the material surface does not feel sticky to the touch. A tack free surface was given a rating of “10” and a highly tacky surface were given a rating of “0” (surface not cured), with ratings ranging therebetween depending on the relative level of tackiness.

### Sanding and Clogging Test Methods:

Sanding was performed using a sanding block with 80-grit sandpaper. The formulation bonded to the upper portion of the panel was manually sanded using a back and forth motion for twenty cycles. A rating of “10” was given if the cured formulation was easily ground into fine particles. Lower ratings, down to a “0” rating, were given if the sanding was not as easy, due to surface tack, for example, and/or fine particles did not form upon sanding. Clogging was evaluated after the sanding process by observing the sandpaper for any filling with sanding residue from the cured formulation. A “10” rating was given if there was no coverage of the 80-grit sandpaper by sanding residue of the formulation. Lower ratings, down to a “0” rating, were given if the sanding residue filled at least a portion of the surface of the 80-grit sandpaper, with a “0” rating indicating complete coverage of the sandpaper with uncured formulation.

### Feather Edge Test Method:

After curing, the formulation on the lower portion of the panel was abraded with 80 grit sand paper and feathered along the edge of the layer in an attempt to get a fine feathered edge. A rating of “10” was given if the cured formulation formed a feather edge and could not be removed by scratching with a fingernail. A “0” rating was given if the cured formulation did not form a feather edge and chipped off. Ratings therebetween indicates a non-smooth and/or soft surface with some material formulation having chipped off the panel

### Scratch Resistance Test Method:

Scratching resistance was determined at the featheredge line after sanding by attempting to scratch the featheredge line with a fingernail, if featheredging is obtainable. This is a measure of adhesion between applied material and panel. A “10” rating was given if the formulation was very difficult to scratch a “0” rating was given if the formulation easily scratched or chipped off the panel, with rating ranging therebetween depending on the relative level of scratch resistance.

### 180-Degree Bending Adhesion Test Method:

A 180-degree bending test was performed by placing the test panel over a ½-inch diameter mandrel with the uncoated side in contact with the mandrel. The panel was then bent approximately 1800 around the mandrel at a uniform rate. A “10 rating” was given when the formulation on the bent panel could be cut with a utility knife and there was no peeling of the formulation from the panel surface. A “0” rating was given if the formulation pops of the panel in the bend region. Ratings therebetween indicated varying degrees of adhesion.

### Formulation Preparation of Examples 1 Through 9 (Ex. 1-Ex. 9)

SDCP, CN973, “EPON 828”, TETDS, AGE, and “DVE2” in amounts indicated in Table 1, below, were added to a type “100 MAX DAC” speed screw-cap plastic mix cup, available from Flak Tek Inc., Landrum, S.C., and then put into a 120° F. (49° C.) oven for 30 minutes, followed by mixing by hand to form uniform solution. “IRGACURE 819”, DPIHFP, camphorquinone, EDMAB, and MTBHQ were added to the cup and put into a 120° F. (49° C.) oven for 20 minutes. Next, all the remaining powder components and wax were added to the cup, and the mixture was homogeneously dispersed for 3 minutes at 3,200 rpm using a high-speed mixer, a model “DAC 600 SPEED MIXER”, available from Flak Tek Inc. EG was then added into the container and mixed. The formulations of Example 1 through 9 are reported in Table 1.

TABLE 1

| | Formulation (parts by weight) | | | | | | | | |
|---|---|---|---|---|---|---|---|---|---|
| Component | Ex. 1 | Ex. 2 | Ex. 3 | Ex. 4 | Ex. 5 | Ex. 6 | Ex. 7 | Ex. 8 | Ex. 9 |
| SDCP | 30 | 30 | 30 | 30 | 29 | 29 | 30 | 31 | 29 |
| CN973 | | 2 | 6.7 | 5 | 7 | 8 | 12 | 13 | 7 |
| EPON 828 | 12 | 11 | 7.7 | 6 | 6 | 6 | 4 | 5 | 8 |
| AGE | | | | 3 | 3 | 3 | 2 | 3 | 3 |
| DVE2 | 9 | 8 | 6.8 | 7 | 7 | 7 | 4 | | 2 |
| EG | 1 | 1.4 | 1.4 | 1.2 | 0.8 | 3 | 0.8 | 1 | 0.8 |
| IRGACURE 819 | | | 0.22 | | 0.15 | 0.4 | 0.4 | 0.5 | |
| DPIHFP | 1 | 1 | 0.7 | 0.5 | 0.35 | 0.4 | 0.5 | 0.5 | 0.8 |
| Camphorquinone | 0.3 | 0.3 | 0.23 | 0.2 | 0.1 | 0.1 | 0.2 | 0.2 | 0.3 |
| EDMAB | 0.2 | 0.2 | 0.2 | 0.2 | | 0.1 | 0.2 | 0.2 | |
| MTBHQ | | | | | 0.02 | 0.01 | 0.02 | 0.02 | 0.02 |
| TETDS | 0.05 | 0.05 | 0.05 | 0.05 | 0.1 | 0.08 | 0.08 | 0.08 | 0.05 |
| ZEOTHIX | 4 | 1 | 1 | 1 | 1 | 1 | 1 | 1 | 1 |
| #10 White | 7 | 8 | 8 | 9 | 9 | 8 | 8 | 8 | 8 |
| Minex | 33 | 34 | 34 | 34 | 34 | 34 | 34 | 34 | 34 |
| PW | 0.2 | 0.2 | 0.2 | 0.2 | 0.2 | 0.2 | 0.2 | 0.2 | 0.2 |
| K-20 | 2 | 2 | 2 | 2 | 2 | 2 | 2 | 2 | 2 |

### Formulation Preparation of Comparative Examples 10 Through 13 (CE-10-CE-13)

SDCP, VHR, TETDS, CN973, “EPON 828”, VV9, “SR351H”, HEMA, and DVE2 in amounts indicated in Table 2, below, were added to a type “100 MAX DAC”, speed screw-cap plastic mix cup, available from Flak Tek Inc., Landrum, S.C., and then put into a 120° F. (49° C.) oven for 30 minutes, followed by mixing by hand to form uniform solution. “IRGACURE 819” or DPIHFP and camphorquinone were then added to the solution. Next all the remaining powder components and wax were added, and the mixture homogeneously dispersed for 3 minutes at 3,000 rpm using a high-speed mixer, a model “DAC 600 SPEED MIXER”, available from Flak Tek Inc. EG was added into the container and mixed. The formulations of Comparative Examples 10 through 13 are reported in Table 2.

TABLE 2

Formulation (parts by weight)

| Component | CE-10 | CE-11 | CE-12 | CE-13 |
|---|---|---|---|---|
| SDCP | 30 | 36 | 35 | 30 |
| VHR | — | — | — | 4 |
| CN973 | 17 | — | — | — |
| EPON 828 | — | 10 | 8 | 3 |
| DVE2 | 5 | 7 | 7 | 6 |
| VV9 | — | 1 | 2 | |
| SR351H | — | — | 3 | 5 |
| HEMA | — | — | — | 4 |
| EG | 1 | — | — | — |
| IRGACURE 819 | 0.8 | 1 | 1 | — |
| DPIHFP | — | — | — | 0.9 |
| Camphorquinone | — | — | — | 0.3 |
| TETDS | 0.07 | 0.05 | 0.05 | 0.05 |
| ZEOTHIX | 3 | 7 | 4 | 7 |
| #10 White | 7 | 5 | 7 | 6 |
| Minex | 32 | 29 | 30 | 31 |
| PW | — | — | 0.2 | — |
| K-20 | — | — | 2 | — |

TABLE 3

| | Surface | | | Featheredge | Scratch | Bending |
|---|---|---|---|---|---|---|
| Example | Tackiness | Sanding | Clogging | Adhesion | Resistance | Adhesion |
| 1 | 7 | 6 | 5 | 6 | 7 | 10 |
| 2 | 7 | 6 | 5 | 6 | 7 | 9 |
| 3 | 7 | 6 | 5 | 7 | 7 | 10 |
| 4 | 7 | 5 | 5 | 6 | 7 | 10 |
| 5 | 5 | 3 | 3 | 7 | 5 | 10 |
| 6 | 7 | 5 | 5 | 6 | 7 | 10 |
| 7 | 7 | 6 | 5 | 7 | 7 | 10 |
| 8 | 6 | 5 | 4 | 7 | 7 | 10 |
| 9 | 5 | 4 | 3 | 7 | 6 | 10 |
| CE-10 | 7 | 3 | 5 | 6 | 5 | 1 |
| CE-11 | 5 | 4 | 5 | 4 | 6 | 0 |
| CE-12 | 3 | 3 | 5 | 1 | 2 | 0 |
| CE-13 | 2 | 2 | 2 | 1 | 2 | 0 |

Various modifications and alterations of this disclosure may be made by those skilled the art without departing from the scope and spirit of the disclosure, and it should be understood that this disclosure is not to be unduly limited to the illustrative embodiments set forth herein.

1. A composition comprising:
a polyester resin comprising at least one α,β-unsaturated ester group;
an epoxy resin;
a compound comprising at least one hydroxyl group; and
a photoinitiator that generates acid on exposure to actinic radiation.

2. The composition of claim 1, wherein the polyester resin comprises a dicyclopentadiene-modified unsaturated polyester resin.

3. The composition of claim 2, wherein the polyester resin comprises a dicyclopentenyl-end-capped unsaturated polyester resin.

4. The composition of claim 1, further comprising at least one of a photosensitizer or an electron donor.

5. The composition of claim 1, further comprising a photosensitizer, wherein the photosensitizer is a visible-light photosensitizer comprising at least one of a diketone, ketocoumarin, an aminoarylketone, or a p-substituted aminostyryl ketone.

6. The composition of claim 1, further comprising an electron donor, wherein the electron donor comprises at least one of 4,4′bis(diethylamino)benzophenone, 4-dimethylaminobenzoic acid, ethyl p-dimethylaminobenzoate, 3-dimethylaminobenzoic acid, 4-dimethylaminobenzoin, 4-dimethylaminobenzaldehyde, N-phenylglycine, 1,2,4-trimethoxybenzene, anthracene, or a substituted anthracene.

7. The composition of claim 1, wherein the photoinitiator that generates acid on exposure to actinic radiation comprises at least one of an aromatic sulfonium salt or an aromatic iodonium salt.

8. The composition of claim 1, further comprising a second photoinitiator that comprises at least one phosphine oxide.

9. The composition of claim 1, wherein the epoxy resin is an aromatic epoxy resin.

10. The composition of claim 1, further comprising a urethane multifunctional acrylate or urethane multifunctional methacrylate.

11. The composition of claim 1, further comprising at least one of ceramic beads, polymer beads, silica, hollow ceramic elements, hollow polymeric elements, alumina, zirconia, mica, dolomite, wollastonite, fibers, talc, calcium carbonate, or clay.

12. A method of repairing a damaged surface, the method comprising:
applying the composition of claim 1 to the damaged surface; and
exposing the composition on the damaged surface to actinic radiation to cure the composition.

13. The method of claim 12, wherein the damaged surface is on at least a portion of a vehicle.

14. The method of claim 12, wherein the actinic radiation is blue light.

15. An article prepared by the method of claim 12.

16. The composition of claim 7, wherein the photoinitiator is diphenyliodonium hexafluorophosphate.

17. The composition of claim 1, further comprising camphorquinone and ethyl p-dimethylaminobenzoate.

18. The composition of claim 1, wherein the compound comprising at least one hydroxyl group is a polyol.

19. The composition of claim 18, wherein the polyol comprises at least one of 1,2-ethanediol, 1,2-propanediol, 1,3-propanediol, 1,4-butanediol, 1,3-butanediol, 2-methyl-1,3-propanediol, 2,2-dimethyl-1,3-propanediol, 2-ethyl-1,6-hexanediol, 1,5-pentanediol, 1,6-hexanediol, 1,8-octanediol, neopentyl glycol, glycerol, trimethylolpropane, 1,2,6-hexanetriol, trimethylolethane, pentaerythritol, quinitol, mannitol, sorbitol, diethylene glycol, triethylene glycol, tetraethylene glycol, glycerine, 2-ethyl-2-(hydroxymethyl)-1,3-propanediol, 2-ethyl-1,3-pentanediol, 1,4-cyclohexanedimethanol, or 1,4-benzene-dimethanol.

20. The composition of claim 1, further comprising a reactive diluent comprising at least one of an acrylate group, a methacrylate group, a vinyl ether group, a vinyl ester group, or an allyl ether group.
